(19) United States
(12) Patent Application Publication
(10) Pub. No.: US 2010/0066045 A1
(43) Pub. Date: Mar. 18, 2010

(54) CART

(75) Inventors: Donald C. Presnell, Stephens City, VA (US); Robert W. Lauer, Winchester, VA (US)

Correspondence Address: MOORE & VAN ALLEN PLLC, P.O. BOX 13706, Research Triangle Park, NC, 27709, US

(73) Assignee: RUBBERMAID COMMERCIAL PRODUCTS, LLC, Winchester, VA (US)

(21) Appl. No.: 12/555,370

(22) Filed: Sep. 8, 2009

Related U.S. Application Data
(60) Provisional application No. 61/096,981, filed on Sep. 15, 2008.

(51) Int. Cl. B62B 3/10

(52) U.S. Cl. 280/47.18

(57) ABSTRACT

The cart of the invention utilizes a sliding support to mount a container onto the cart. In one embodiment the container is a linen bag mounted to the cart handles. A shelf or platform is located below the sliding support. The sliding support allows the container to be stored either under the support and over the platform, or if more storage space is required, the sliding support allows the container to slide on the support, providing open space for items to be placed on the platform. The container may also be easily slid off of the cart for removal by the user. The container may be provided with a telescopic handle and wheels for easy transport of the container and its contents.

This application claims benefit of priority under 35 U.S.C. §119(e) to the filing date of to U.S. Provisional Application No. 61/096,981, as filed on Sep. 15, 2008, which is incorporated herein by reference in its entirety.

### FIELD OF THE INVENTION

The invention relates generally to carts and more particularly to a housekeeping or service cart that increases storage capacity and facilitates removal and transport of filled containers.

### BACKGROUND OF THE INVENTION

Housekeeping carts are typically used for room make-up and linen changes in, for example, the hospitality and senior care industries. Such carts typically have an attached fabric linen bag for stowing the dirty towels, bedsheets or the like. Existing laundry/linen bags typically have grommets surrounding the upper lip of the bag that are hung from the handles of the housekeeping cart. Some linen bags also have strings or ties that can be tied around the handles of the cart to hang. In either case, the bags typically are suspended within the handles of the carts so that the room attendant can place dirty linens into the bags as they proceed along their room service route. The typical cart usually stocks supplies to make up a number of rooms over the course of a day. For example one stocked cart may service eighteen rooms during the course of a day. The fully loaded cart may store fresh replacement towels and bed linens, amenities (such as soaps and shampoos), as well as a trash bag to collect waste from the wastebaskets. The fully loaded housekeeping cart sometimes falls short of the space needed to fully equip it for an entire work shift.

### SUMMARY OF THE INVENTION

The cart of the invention utilizes a sliding support to mount a container onto the cart. In one embodiment the container is a linen bag and the sliding support functions as the cart handles. A shelf or platform is located below the sliding support. The sliding support allows the container to be stored either under the support, directly over the platform, or, if more storage space is required, the sliding support allows the container to slide on the support, providing open space for items to be placed on the platform. The container may also be easily removed from the cart by the user. The container may be provided with a telescopic handle and wheels for easy transport of the container and its contents. The sliding mounting system and the container with wheels and handle allow the user to safely and easily remove and transport the heavy loads.

### BRIEF DESCRIPTION OF THE DRAWINGS

FIG. 1 is a perspective view of one embodiment of a cart of the invention.

FIG. 2 is a perspective view showing the sliding support of the cart of FIG. 1.

FIG. 3 is a perspective view showing a detailed view of the sliding support engaged by a container.

FIG. 4 is a detailed view of a platform of the cart of FIG. 1.

FIG. 5 is a perspective view of another embodiment of a cart of the invention.

FIG. 6 is a perspective view of one embodiment of a container used in the cart of the invention.

FIG. 7 is a perspective view of another embodiment of a container used in the cart of the invention.

FIG. 8 is a perspective view of the container of FIG. 7 in a disassembled condition.

### DETAILED DESCRIPTION OF PREFERRED EMBODIMENTS OF THE INVENTION

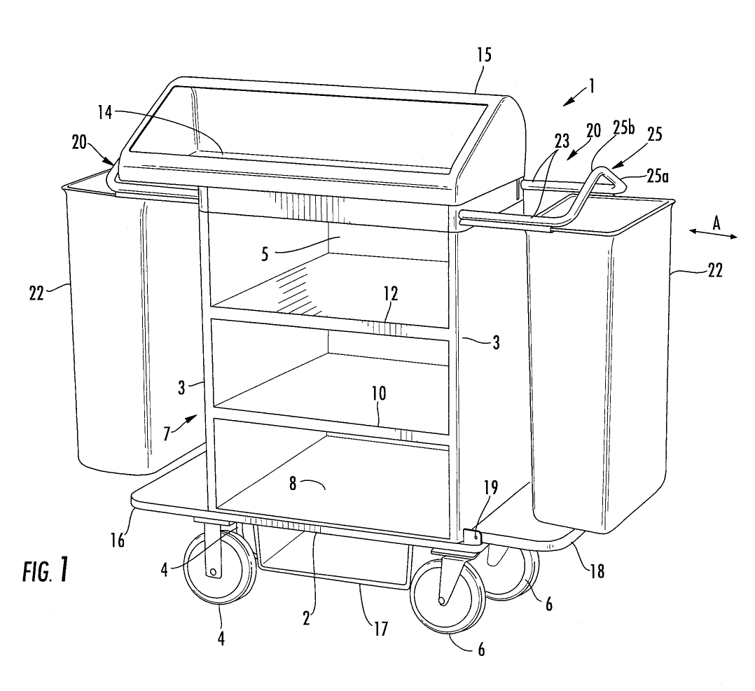

Referring to FIG. 1 one embodiment of the cart of the invention is shown generally at 1 comprising a base 2 mounted on fixed wheels 4 and casters or turning wheels 6. A pair of side walls 3 and a back wall 5 extend substantially vertically from base 2 to define cabinet portion 7. Base 2 defines a shelf 8 and cabinet portion 7 supports a plurality of shelves 10, 12 and 14 for storing cleaning supplies such as towels, bed linens, amenities and the like. The shelves may be open as shown in the drawings or may be closed by locking doors. Further, the cart may include additional shelves, drawers, cabinets, locking hood 15 or other storage devices. The cart 1 also includes a between the wheels storage compartment 17 that is located below base 2 and between the wheels 4 and 6.

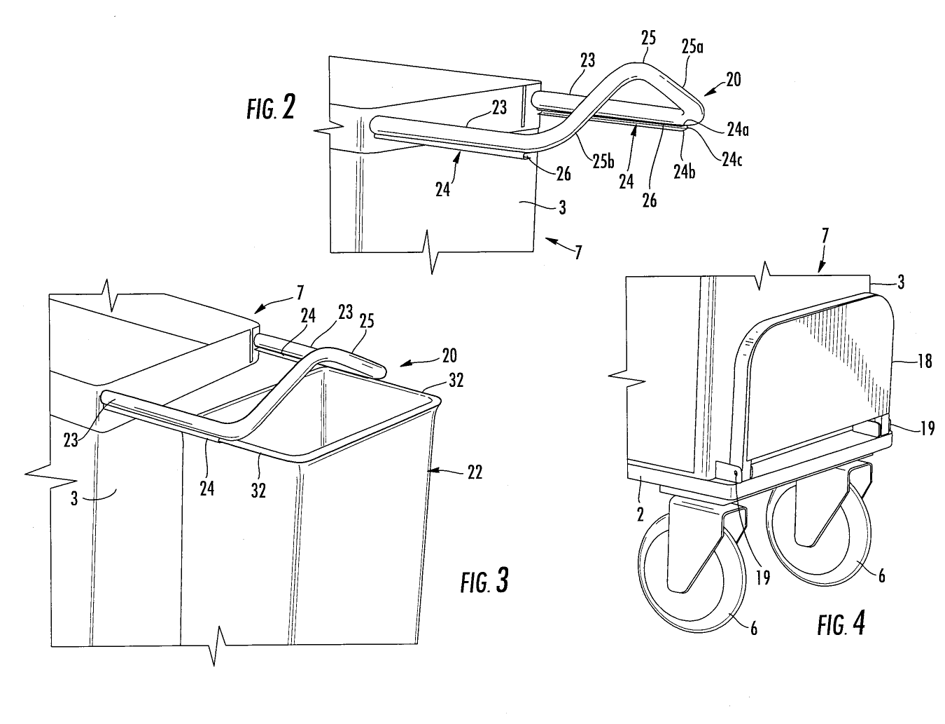

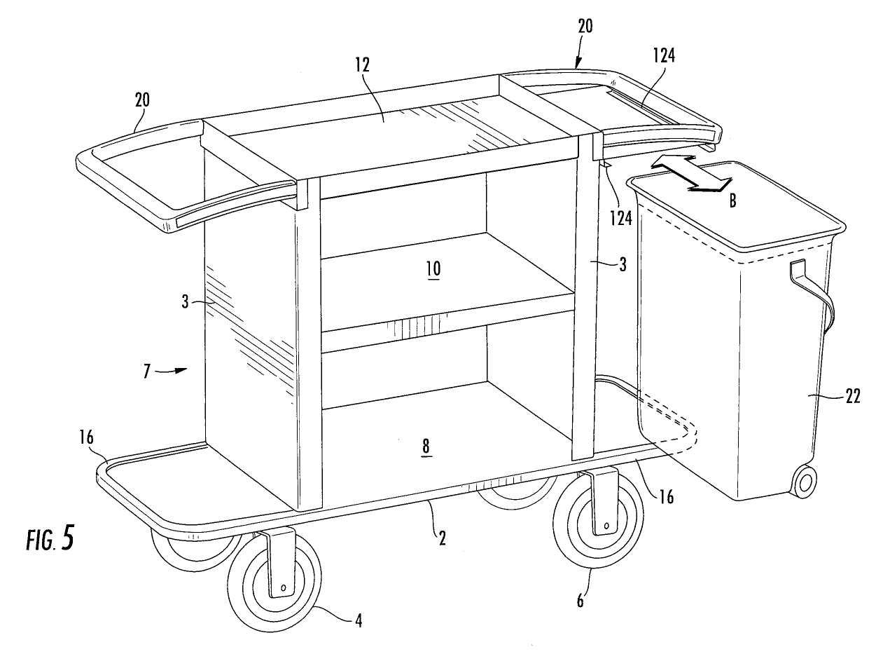

Extending from either side of base 2 near the bottom of cart 1 are platforms 16 and 18 that extend substantially horizontally and are used to support articles as will hereinafter be described. In the illustrated embodiment platform 16 is formed integrally with base 2 such that it is permanently fixed in the illustrated horizontal position. Platform 18 is pivoted to base 2 at pivots 19 such that it can be pivoted from the substantially horizontal position shown in FIG. 1 to a substantially vertical position shown in FIG. 4 when not in use. Both platforms may be permanently mounted such as platform 16 or both platforms may be pivotably mounted such as platform 18.

Located above platforms 16 and 18 are sliding supports 20. Each support 20 is used to slidably support a storage container 22 such as the illustrated laundry bags as will hereinafter be described. The laundry bags may be made of a flexible material such as woven fabric or Nylon or rigid storage compartments made of a relatively rigid plastic may be used. Supports 20 are also used as handles that can be gripped by a user to propel the cart on wheels 4 and 6.

Each support 22 includes a pair of members 23 that extend substantially perpendicularly from cabinet member 7. Members 23 are connected by a cross member 25. Cross member 25 includes a first portion 25a and a second portion 25b that are disposed at angle relative to horizontal such that the center portion of member 25 is raised. The raised center portion allows easy access to the open upper end of the container 22 such that the handle does not interfere with access to the container as shown in FIG. 3.

Each of supports 20 include a pair of rails 24 to slidably support the storage container 22 such as a laundry bag. While the sliding storage containers 22 are illustrated as a laundry bags the storage container may be for other storage such as a waste basket, article storage or the like. In the illustrated embodiment each rail 24 includes a top wall 24a, bottom wall 24b and back wall 24c that define a channel 26 where the open side of the channels 26 face one another and are arranged substantially parallel to one another and extend substantially perpendicularly from the cabinet portion 7 of cart 1. The container 22 includes a pair of substantially parallel projections 32 at its upper end that fit into the channels 26 such that the projections 32 can be inserted into the channels to suspend container 22 from rails 24. The container may be easily removed from the cart by sliding the projections 32 from the rails 24. The projections 32 slide in the channels 26 such that the container 22 can be slid relative to side wall 3 to create a space between the side walls 3 and the bags 22. The distance between the side wall 3 and bag 22 can be varied by simply sliding the bag in the channel towards or away from the side wall 3 in the direction of arrow A.

While the rails 24 are shown as U-shaped channel that are open toward the interior of the cart, the rails could have other configurations. For example, the channels could open toward the exterior or top of the cart and the bag could be formed with projections 32 that are arranged to mate with the rails. Further, the rails could include the projection and the container may include the channel. Other configurations of the sliding support and bag may be used to allow the container to move relative to the cabinet portion 7.

In use, the containers 22 can be positioned closely adjacent to the side walls 3 to minimize the footprint of the cart. To increase the storage of the cart either or both of the containers 22 can be slid on the sliding supports 20 to create a space between the containers 22 and side walls 30 as shown in FIGS. 1 and 3. Extra articles can then be supported on platforms 16 and 18. The spacing between the side walls 30 and containers 22 can be adjusted by moving the container on supports 20.

An alternate embodiment of the cart is shown in FIG. 5 where like reference numerals are used to identify like elements previously identified in the embodiment of FIG. 1. In the cart of FIG. 5, the rails 124 are mounted on support 20 so as to extend parallel to the side walls 30 such that the container 22 is slid transversely to the cart in the direction of arrow B. In this embodiment the extra storage space on platform 18 is located behind container 22 rather than between container and the cabinet portion 7.

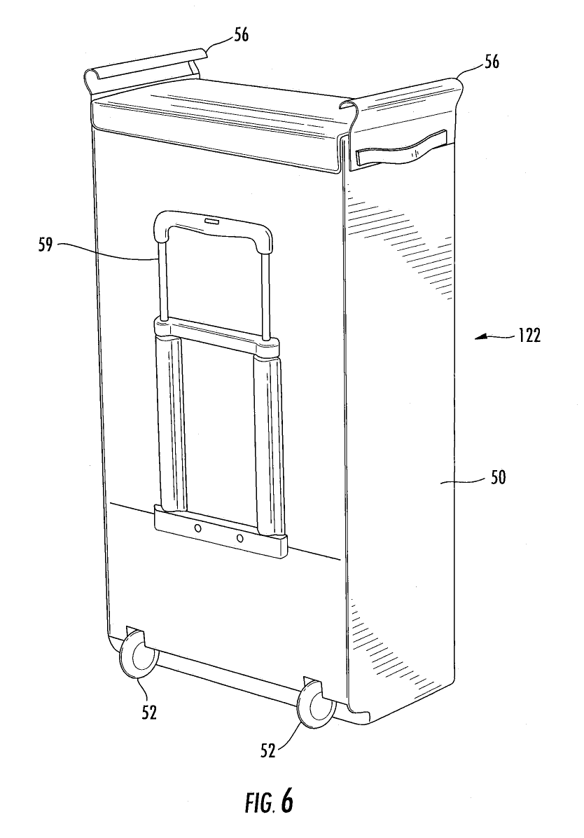

Referring to FIG. 6, the laundry bag 122 may comprise a wall 50 that defines an interior space having an opening on the top for receiving articles such as dirty linen and towels. The back of the bag 122 includes wheels 52 located near the bottom edge of the bag 122 and an extendable handle 59. The handle 59 can be grasped by a user and extended such that the bag 122 can be tilted and the bag rolled on the wheels 52.

In the embodiment of the bag of FIG. 6, the support for sliding the bag comprises hooks 56 located on the top edges of the bag. The hooks 56 fit over the members 23 such that the bag is supported on members 23 and can be slid relative thereto.

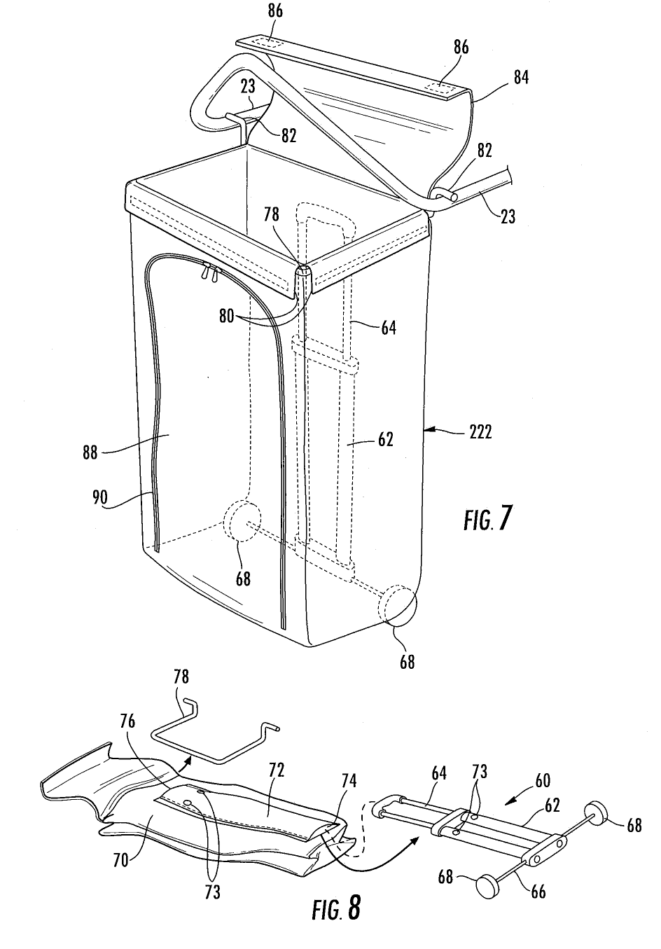

In the embodiment of FIGS. 7 and 8 the wheels and telescoping handles are assembled in a removable unit 60 such that they can be removed from the bag 222. Once the wheels and handle are removed, the bag can be laundered. Unit 60 comprises a body portion 62 that receives handle portion 64 such that the handle portion 64 is able to telescope relative to the upper end of the body portion 62. An axle 66 is supported at the lower end of the body portion 62 that supports wheels or rollers 68. A sleeve 72 is secured to the back wall 70 of bag 22 such that the handle portion 64 and body portion 62 can be inserted into the bottom opening 74 of sleeve 72. Sleeve 72 may be made of the same flexible material as bag 222. The handle portion 64 extends out of the top opening 76 of sleeve 72 such that it can be grasped by the user and the wheels are disposed outside of the bottom opening 74 near the bottom of the bag. Fasteners such as snaps 73 are used to secure the unit 60 to the bag.

The bag also includes a member 78 such as a bent metal rod that is removably inserted into a sleeve 80 formed at the upper edge of the bag. The member 78 includes hook portions 82 that extend from the sleeves at either side of the bag. The hook portions 82 are dimensioned to extend over handle portions 23 such that the bag can be suspended by the hook portions 82 on members 23 of the cart. Member 78 provides the structural rigidity that maintains the bag in the open position. When member 78 is removed, the bag can be collapsed as shown in FIG. 8.

The bag may include a top flap 84 that can be used to close the open top of the bag. A fastener such as a hook and loop fastener 86 or zipper can be used to secure the top flap 84 closed. The bag is also provided with a large front a flap 88 that can be opened to remove the contents of the bag. The flap 88 is secured closed by a zipper 90 or other fastener.

Specific embodiments of an invention are disclosed herein. One of ordinary skill in the art will recognize that the invention has other applications in other environments. Many embodiments are possible. The following claims are in no way intended to limit the scope of the invention to the specific embodiments described above.

1. A cart comprising:
a cabinet comprising a shelf;
a platform extending from said cabinet;
a support extending over said platform; and
a container slidably supported on said support, said container movable between a first position in which it closely adjacent the cabinet and a second position where it is spaced from said cabinet such that said platform can be used for storage.

2. The cart of claim 1 wherein said platform pivots between a substantially horizontal position to a substantially vertical position.

3. The cart of claim 1 wherein said container is suspended from said support.

4. The cart of claim 1 wherein said support has a handle portion that can be grasped by a user to move the cart.

5. The cart of claim 1 further including wheels for supporting the cart.

6. The cart of claim 1 a second support and a second container slidably supported on said second support, said second container movable between a first position in which it closely adjacent the cabinet and a second position where it is spaced from said cabinet.

7. The cart of claim 1 further including a rail on said support that is engaged by a mating element on said container.

8. The cart of claim 1 wherein said container is a flexible bag.

9. The cart of claim 8 wherein said bag is made of fabric.

10. The cart of claim 1 wherein said container includes wheels for supporting the container when said container is removed from said cart.

11. The cart of claim 10 wherein said container includes a handle that is held by the user to roll the container on said wheels.

12. The cart of claim 1 wherein said container includes hooks that extend over said support.

13. The cart of claim 11 wherein said wheels and said handle are removably mounted on said container.

14. The cart of claim 11 wherein said wheels and handle are located in a unit that is removable from said container

15. The cart of claim 14 wherein said unit is removably inserted into a sleeve on said container.

16. The cart of claim 15 wherein said unit is inserted such that said handle extends from the top of the sleeve and said wheels extend from the bottom of the sleeve.

17. The cart of claim 1 wherein said handle is shaped to allow access to said container when said container is in either the first or second positions.
